(19) United States
(12) Patent Application Publication
(10) Pub. No.: US 2026/0262884 A1
(43) Pub. Date: Sep. 10, 2026

(54) Kitchen Stand Assembly

(71) Applicant: Jo Ellen Beabout, New Castle, PA (US)

(72) Inventor: Jo Ellen Beabout, New Castle, PA (US)

(21) Appl. No.: 19/074,602

(22) Filed: Mar. 10, 2025

(51) Int. Cl. A47J 47/16

(52) U.S. Cl. CPC A47J 47/16

(57) ABSTRACT

A kitchen stand assembly for holding cookware at a tilted orientation includes a base and a set of channels that extend through the base. Each channel of the set of channels includes an inlet and an outlet that is angularly offset from the inlet. A set of rods are coupled to the base. Each rod of the set of rods is positioned in a respective channel of the set of channels. The set of rods are angled to extend downwardly through the base and outwardly relative to each other to define a cradle that is designed to support a cookware above the base.

### TITLE OF THE INVENTION

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to kitchen tools and more particularly pertains to a new kitchen tool for holding cookware at a tilted orientation.

(2) Description of Related Art including information disclosed under 37 CFR 1.97 and 1.98.

The prior art relates to kitchen tools. Some of the most common kitchen tools are containers such as pots, pans, skillets, and bowls. These tools are used for preparing and cooking food and are therefore often filled and emptied during the cooking process. The containers themselves can be very heavy, for example because they can be made from glass, cast iron, and other heavy materials. The weight of the containers makes them difficult to hold, tilt, and manipulate when emptying the containers. The size of the containers can also make manipulation difficult because many of the containers are large and cumbersome. The prior art discloses some stands for kitchen tools and containers, but those tools are typically designed for use with a single, particular container. To hold the weight of the containers, these stands are also typically quite heavy and therefore difficult to reposition around the kitchen. Thus, there is a need in the art for a device that can hold and tilt containers used in the kitchen. Ideally, such a device would be adjustable to hold many different types and sizes of containers, while also being light weight enough to easily move around the kitchen.

### BRIEF SUMMARY OF THE INVENTION

An embodiment of the disclosure meets the needs presented above by generally comprising a base and a set of channels that extend through the base. Each channel of the set of channels includes an inlet and an outlet that is angularly offset from the inlet. A set of rods are coupled to the base. Each rod of the set of rods is positioned in a respective channel of the set of channels. The set of rods are angled to extend downwardly through the base and outwardly relative to each other to define a cradle that is configured to support a cookware above the base.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a kitchen stand assembly according to an embodiment of the disclosure.

FIG. 2 is a phantom side view of an embodiment of the disclosure.

FIG. 3 is a side view of an embodiment of the disclosure.

FIG. 4 is an in-use view of an embodiment of the disclosure.

FIG. 5 is an exploded view of an embodiment of the disclosure.

FIG. 6 is an isometric view of an embodiment of the disclosure.

FIG. 7 is an in-use view of an embodiment of the disclosure.

### DETAILED DESCRIPTION OF THE INVENTION

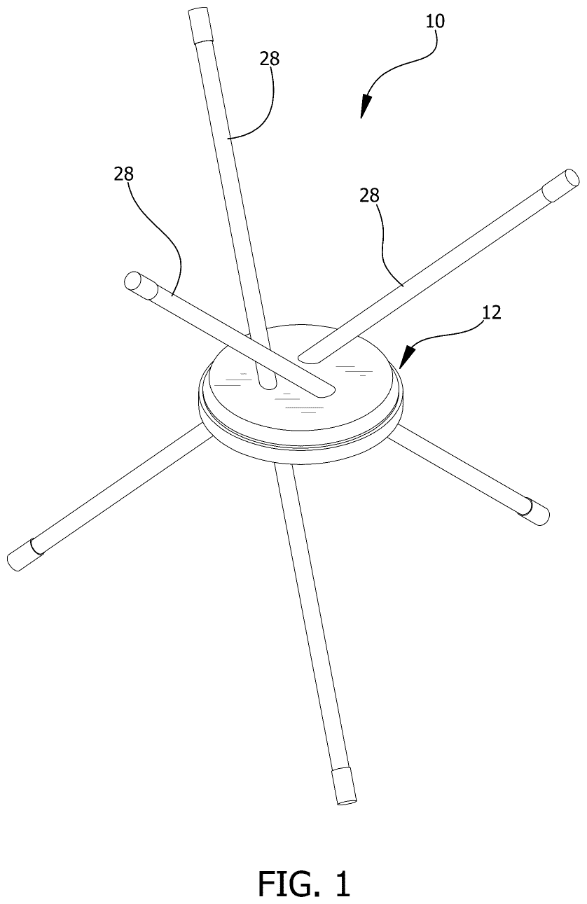

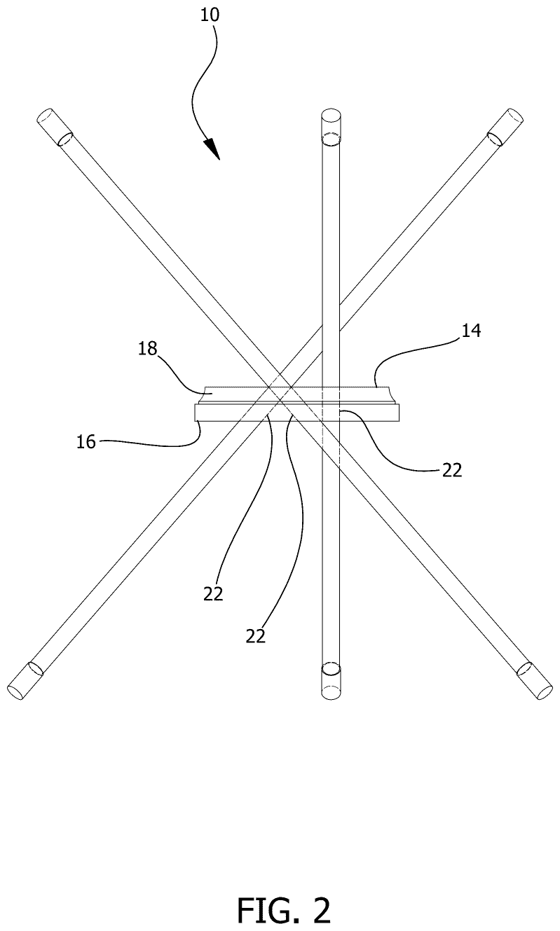

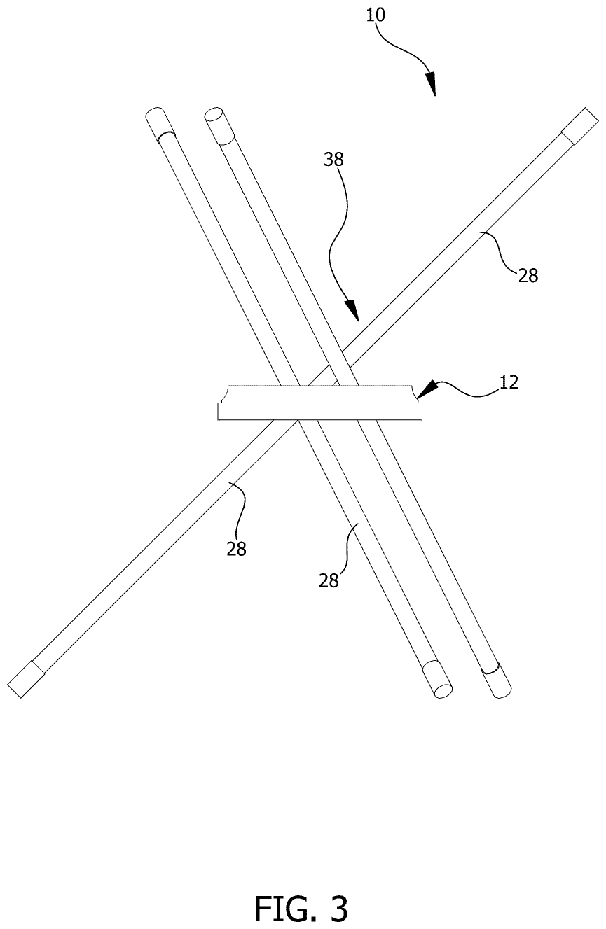

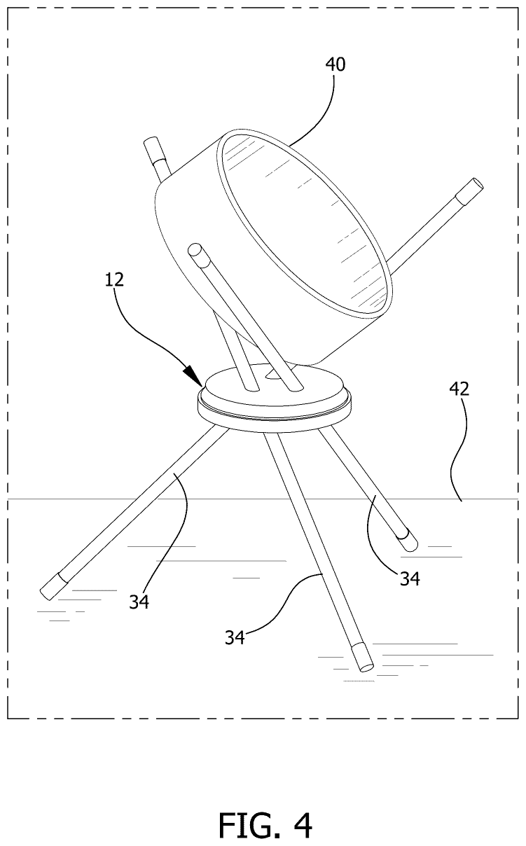

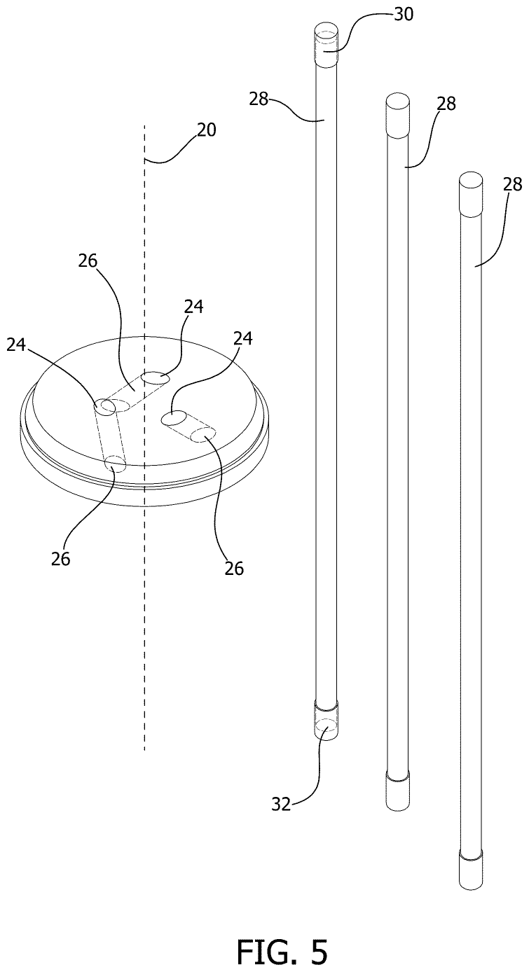

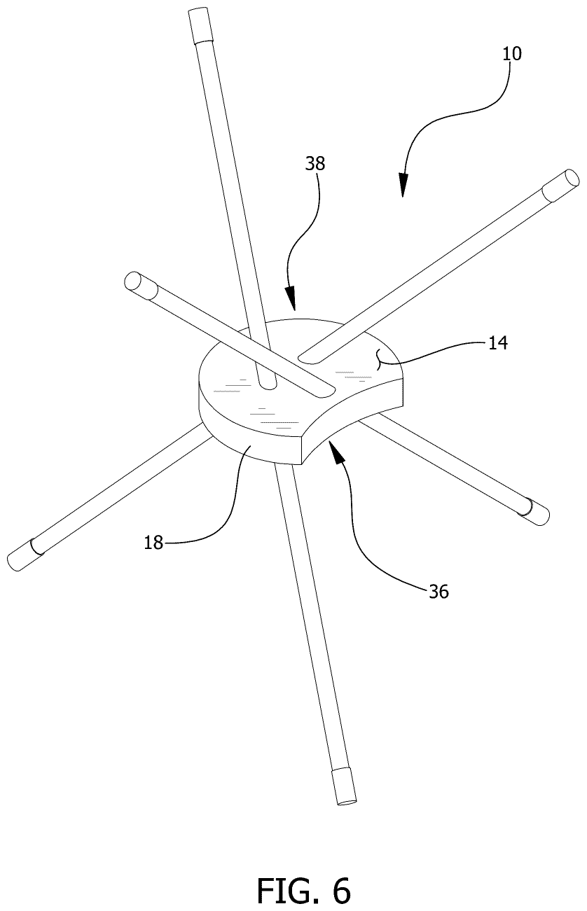

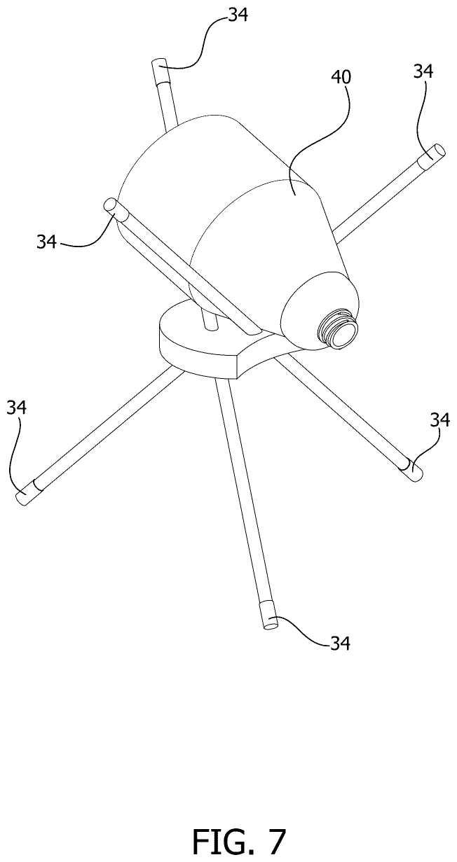

With reference now to the drawings, and in particular to FIGS. 1 through 7 thereof, a new kitchen tool embodying the principles and concepts of an embodiment of the disclosure and generally designated by the reference numeral 10 will be described.

As best illustrated in FIGS. 1 through 7, the kitchen stand assembly 10 generally comprises a base 12 that has a top wall 14, a bottom wall 16, and a peripheral wall 18 that is coupled to and extends between the top wall 14 and the bottom wall 16. The top wall 14 and the bottom wall 16 may each be circular. The top wall 14 may be planar. The bottom wall 16 may also be planar. Generally, the base 12 has a central axis 20 that extends vertically between the top wall 14 and the bottom wall 16. The central axis 20 is centered on each of the top wall 14 and the bottom wall 16 extends perpendicularly to each of the top wall 14 and the bottom wall 16.

A set of channels 22 extend through the base 12. The set of channels 22 may be equidistantly spaced from each other relative to the central axis 20 of the base 12. Generally, each channel of the set of channels 22 includes an inlet 24 that extends inwardly through the top wall 14. An outlet 26 extends outwardly through the bottom wall 16. The outlet 26 is angularly offset from the inlet 24 wherein the inlet 24 and the outlet 26 of each channel of the set of channels 22 defines an angle that is between 30.0° and 60.0°. For example, the inlet 24 may be drilled through the top wall 14 at an angle that is between 30.0° and 60.0° such that the outlet 26 is angularly offset from the inlet 24. The outlet 26 of each channel of the set of channels 22 is therefore spaced from the central axis 20 by a distance exceeding a distance between the inlet 24 of an associated channel of the set of channels 22 and the central axis 20. In other words, each channel of the set of channels 22 is generally angled to extend downwardly through the top wall 14 and outwardly toward the peripheral wall 18 of the base 12.

A set of rods 28 are coupled to the base 12. In some embodiments, the set of rods 28 may be removably coupled to the base 12. Each rod of the set of rods 28 is positioned in a respective channel of the set of channels 22 wherein each rod of the set of rods 28 extends inwardly through the inlet 24 and outwardly through the outlet 26 of the respective channel of the set of channels 22. Thus, the set of rods 28 are angled to extend downwardly through the top wall 14 of the base 12 and outwardly toward the peripheral wall 18 of the base 12 to define a cradle 38 that is configured to support a cookware 40 above the base 12. Examples of the cookware 40 include, but are not limited to, pots, pans, mixing bowls, sauce pans, Dutch ovens, and other containers that are used for cooking and baking.

The set of rods 28 are generally equivalent in size. More specifically, each rod of the set of rods 28 has a length that exceeds a distance between the top wall 14 and the bottom wall 16 of the base 12. The set of rods 28 therefore extend downwardly past the bottom wall 16 whereby the set of rods 28 are configured to support the base 12 above a surface 42, such as a table or a countertop. The angle of each channel of the set of channels 22 is configured to tilt the cookware 40 toward the surface 42 while the cookware 40 is supported above the base 12 wherein the set of rods 28 are configured to facilitate a user in emptying the cookware 40.

Each rod of the set of rods 28 may have an upper end 30 that is positioned above the top wall 14 of the base 12. Each rod of the set of rods 28 may be movably positioned within the respective channel of the set of channels 22. In such embodiments, the set of rods 28 are upwardly and downwardly movable relative to the base 12 to adjust a size of the cradle 38. Movement of the set of rods 28 within the set of channels 22 is configured to facilitate adjustment of a size of the cookware 40 that can be supported by the set of rods 28 above the base 12.

A lower end 32 of each rod of the set of rods 28 is generally positioned beneath the bottom wall 16 of the base 12. Downward movement of the upper end 30 of each rod of the set of rods 28 moves the lower end 32 of each rod of the set of rods 28 downwardly away from the bottom wall 16 of the base 12. Accordingly, downward movement of the lower end 32 of each rod of the set of rods 28 increases a distance between the lower end 32 of each rod of the set of rods 28. Adjustment of the distance between the lower end 32 of each rod of the set of rods 28 is configured to facilitate adjustment of a weight of the cookware 40 is supportable by the set of rods 28. For example, as the lower end 32 of each rod of the set of rods 28 is moved away from the lower end 32 of the other rods of the set of rods 28, the center of gravity of the base 12, and the cookware 40 within the cradle 38, is moved closer to the surface 42 and is widened over the surface 42, facilitating the set of rods 28 in supporting heavier embodiments of the cookware 40.

A set of end caps 34 may be coupled to the set of rods 28. In preferred embodiments, each of the upper end 30 and the lower end 32 of each rod of the set of rods 28 is covered by a respective end cap of the set of end caps 34. The set of end caps 34 may comprise a roughened material that is configured to increase friction between the lower end 32 of each rod of the set of rods 28 and the surface 42 whereby the set of end caps 34 are configured to stabilize a position of the base 12 above the surface 42. Examples of the roughened material include, but are not limited to, be rubber, vinyl, or another material with a high coefficient of friction. The set of end caps 34 may have a diameter that exceeds a diameter of the set of channels 22 wherein the set of end caps 34 are configured to secure each rod of the set of rods 28 within the respective channel of the set of channels 22.

A notch 36 may extend inwardly through the peripheral wall 18 of the base 12. The notch 36 is generally concavely arcuate wherein the notch 36 is configured to be positionable around the cookware 40 while the cookware 40 is positioned adjacent to the base 12. The notch therefore facilitates angling the cookware 40 toward the surface 42. The notch 36 may also facilitate placing the cookware 40 closer to the surface 42, and may inhibit contents of the cookware 40 from spilling onto the base 12 as the user is removing the contents from the cookware 40.

In use, the set of rods 28 can be moved upwardly and downwardly within the set of channels 22 to adjust the size of the cradle 38 such that the cradle 38 has a size that is complementary to a size of the cookware 40. In other words, the set of rods 28 can be moved within the set of channels 22 so that the cradle 38 can hold the cookware 40 above the base 12. The angle of the set of channels 22, and thus the set of rods 28, tilts the cookware 40 to make it easier for contents of the cookware 40 to be removed from the cookware 40. For example, the user may be preparing a cake. The cookware 40 may be a mixing bowl. The mixing bowl can be placed in the cradle 38, tilted toward a baking pan so that the user can easily scrape the batter into the baking pan. The notch 36 may be preferred so that the cookware 40 can be positioned more closely to the base 12 within the cradle 38, and to inhibit the contents of the cookware 40 from spilling onto the base 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A stand device comprising:
a base;
a set of channels extending through the base, each channel of the set of channels
including:
an inlet; and
an outlet being angularly offset from the inlet; and
a set of rods being coupled to the base, each rod of the set of rods being positioned in a respective channel of the set of channels whereby the set of rods are angled to extend downwardly through the base and outwardly relative to each other to define a cradle being configured to support a cookware above the base.

2. The stand device of claim 1, the base further comprising a top wall, a bottom wall, and a peripheral wall being coupled to and extending between the top wall and the bottom wall, the top wall being circular.

3. The stand device of claim 2, wherein the bottom wall is circular.

4. The stand device of claim 2, the base further comprising a central axis extending vertically between the top wall and the bottom wall.

5. The stand device of claim 4, wherein the central axis is centered on each of the top wall and the bottom wall wherein the central axis extends perpendicularly to each of the top wall and the bottom wall.

6. The stand device of claim 5, wherein the outlet of each channel of the set of channels is spaced from the central axis by a distance exceeding a distance between the inlet of an associated channel of the set of channels and the central axis.

7. The stand device of claim 2, wherein each channel of the set of channels is angled to extend downwardly through the top wall and outwardly toward a peripheral wall of the base.

8. The stand device of claim 2, wherein the inlet of each channel of the set of channels extends inwardly through the top wall of the base and wherein the outlet of each channel of the plurality of channels extends outwardly through the bottom wall of the base.

9. The stand device of claim 1, wherein the inlet and the outlet of each channel of the set of channels defines an angle being between 30.0° and 60.0°.

10. The stand device of claim 1, the base further comprising a top wall, a bottom wall, and a peripheral wall being coupled to and extending between the top wall and the bottom wall.

11. The stand device of claim 10, further comprising a notch extending inwardly through the peripheral wall of the base, the notch being concavely arcuate wherein the notch is configured to be positionable around the cookware while the cookware is positioned adjacent to the base to facilitate angling the cookware toward the surface.

12. The stand device of claim 1, each rod of the set of rods further comprising:
an upper end being positioned above the base; and
a lower end being positioned beneath the base.

13. The stand device of claim 12, wherein each rod of the set of rods is movably positioned within the respective channel of the set of channels wherein the set of rods are upwardly and downwardly movable relative to the base to adjust a size of the cradle whereby movement of the set of rods within the set of channels is configured to facilitate adjustment of a size of the cookware being supported by the set of rods above the base.

14. The stand device of claim 13, wherein downward movement of the upper end of each rod of the set of rods moves the lower end of each rod of the set of rods downwardly away from the base and wherein downward movement of the lower end of each rod of the set of rods increases a distance between the lower end of each rod of the set of rods whereby adjustment of the distance between the lower end of each rod of the set of rods is configured to facilitate adjustment of a weight of the cookware being supportable by the set of rods.

15. The stand device of claim 12, further comprising a set of end caps being coupled to the set of rods wherein each of the upper end and the lower end of each rod of the set of rods is covered by a respective end cap of the set of end caps.

16. The stand device of claim 15, wherein the set of end caps comprise a roughened material being configured to increase friction between the lower end of each rod of the set of rods and the surface whereby the set of end caps are configured to stabilize a position of the base above the surface.

17. The stand device of claim 15, wherein the set of end caps have a diameter exceeding a diameter of the set of channels wherein the set of end caps are configured to secure each rod of the set of rods within the respective channel of the set of channels.

18. A stand device comprising:
a base having a top wall, a bottom wall, and a peripheral wall being coupled to and extending between the top wall and the bottom wall, the top wall being circular, the bottom wall being circular, the top wall being planar, the bottom wall being planar, the base having a central axis extending vertically between the top wall and the bottom wall, the central axis being centered on each of the top wall and the bottom wall wherein the central axis extends perpendicularly to each of the top wall and the bottom wall;
a set of channels extending through the base, the set of channels being equidistantly spaced from each other relative to the central axis of the base, each channel of the set of channels including:
an inlet extending inwardly through the top wall; and
an outlet extending outwardly through the bottom wall, the outlet being angularly offset from the inlet wherein the inlet and the outlet of each channel of the set of channels defines an angle being between 30.0° and 60.0°, the outlet of each channel of the set of channels being spaced from the central axis by a distance exceeding a distance between the inlet of an associated channel of the set of channels and the central axis wherein each channel of the set of channels is angled to extend downwardly through the top wall and outwardly toward the peripheral wall of the base;
a set of rods being coupled to the base, each rod of the set of rods being positioned in a respective channel of the set of channels wherein each rod of the set of rods extends inwardly through the inlet and outwardly through the outlet of the respective channel of the set of channels whereby the set of rods are angled to extend downwardly through the top wall of the base and outwardly toward the peripheral wall of the base to define a cradle being configured to support a cookware above the base, the set of rods being equivalent in size, the set of rods having a length exceeding a distance between the top wall and the bottom wall of the base wherein the set of rods extend downwardly past the bottom wall whereby the set of rods are configured to support the base above a surface, the angle of each channel of the set of channels being configured to tilt the cookware toward the surface while the cookware is supported above the base wherein the set of rods are configured to facilitate a user in emptying the cookware, each rod of the set of rods including:
an upper end being positioned above the top wall of the base, each rod of the set of rods being movably positioned within the respective channel of the set of channels wherein the set of rods are upwardly and downwardly movable relative to the base to adjust a size of the cradle whereby movement of the set of rods within the set of channels is configured to facilitate adjustment of a size of the cookware being supported by the set of rods above the base; and
a lower end being positioned beneath the bottom wall of the base wherein downward movement of the upper end of each rod of the set of rods moves the lower end of each rod of the set of rods downwardly away from the bottom wall of the base and wherein downward movement of the lower end of each rod of the set of rods increases a distance between the lower end of each rod of the set of rods whereby adjustment of the distance between the lower end of each rod of the set of rods is configured to facilitate adjustment of a weight of the cookware being supportable by the set of rods;
a set of end caps being coupled to the set of rods wherein each of the upper end and the lower end of each rod of the set of rods is covered by a respective end cap of the set of end caps, the set of end caps comprising a roughened material being configured to increase friction between the lower end of each rod of the set of rods and the surface whereby the set of end caps are configured to stabilize a position of the base above the surface, the set of end caps having a diameter exceeding a diameter of the set of channels wherein the set of end caps are configured to secure each rod of the set of rods within the respective channel of the set of channels; and
a notch extending inwardly through the peripheral wall of the base, the notch being concavely arcuate wherein the notch is configured to be positionable around the cookware while the cookware is positioned adjacent to the base to facilitate angling the cookware toward the surface.
